(19) United States
(12) Patent Application Publication
(10) Pub. No.: US 2025/0306372 A1
(43) Pub. Date: Oct. 2, 2025

(54) ASYMMETRIC BINOCULAR NEAR-EYE DISPLAY

(71) Applicant: Lumus Ltd., Ness Ziona (IL)

(72) Inventor: Eitan RONEN, Rechovot (IL)

(73) Assignee: Lumus Ltd., Ness Ziona (IL)

(21) Appl. No.: 18/855,132

(22) PCT Filed: Jun. 19, 2023
(86) PCT No.: PCT/IB2023/056334

§ 371 Date: Oct. 8, 2024

Related U.S. Application Data
(60) Provisional application No. 63/353,645, filed on Jun. 20, 2022.

(51) Int. Cl. G02B 27/01

(52) U.S. Cl. CPC G02B 27/0172; G02B 2027/0123; G02B 2027/0132; G02B 2027/0143; G02B 2027/0147; G02B 2027/0178

(57) ABSTRACT

In some implementations, the device may include a first optical system corresponding to a first eye of the user and a second optical system corresponding to a second eye of the user, each of the first and second optical systems having: a projection unit configured to project light corresponding to an image; a lens operably including an optical element configured to direct the light from the projection unit to a respective eye motion box of the user. In addition, the device may include where the lens of the first optical system and the lens of the second optical system are symmetrically disposed about a mid-sagittal plane corresponding to a center of the nose bridge of the user, and where the first and second optical systems are geometrically asymmetric about the mid-sagittal plane.

### FIELD OF THE INVENTION

The present invention relates to optical systems and, in particular, it concerns improving performance of binocular near-eye displays by exploiting asymmetric effects.

### BACKGROUND OF THE INVENTION

Consumer demands for improved human-computer interfaces have led to an increased interest in high-quality image head-mounted displays (HMDs) or near-eye displays, commonly known as smart glasses. These devices can provide virtual reality (VR) or augmented reality (AR) experiences, enhancing the way users interact with digital content and their surrounding environment.

Consumers are seeking better image quality, immersive experiences, and greater comfort when using HMDs. They expect displays with high resolution, vibrant colors, and minimal distortion to create a realistic and enjoyable viewing experience. Additionally, comfort is a crucial factor since users often wear these devices for extended periods. Consumers desire lightweight, sleek designs that are less obtrusive and more convenient to wear in various scenarios. Smaller devices also offer improved portability, making them easier to carry and use in different environments. As such, there is a growing demand for higher performing yet smaller and more compact HMDs.

### SUMMARY OF THE INVENTION

The present invention introduces a new and innovative near-eye display system called an asymmetric binocular near-eye display (BNED). This system consists of two optical systems (OS)—one for the left eye and one for the right eye—each projecting an image directly to the respective eye of the user. The user's brain combines these two images to create a unified visual experience. While most BNED systems use identical optical systems for both eyes (or at least with symmetry around the center of the nose bridge (CNB)) asymmetrical OSs can be employed. One potential application of asymmetrical OSs is expanding the field of view (FOV) by utilizing the non-overlapping FOV of each OS, effectively taking advantage of the binocular effect to increase the overall FOV.

In accordance with some embodiments of the present invention, the center of symmetry of glasses is assumed to be the Center of the Nose Bridge (CNB).

In accordance with some embodiments of the present invention, the binocular feature of the NED is exploited to improve different features where the system is asymmetrical-ABN (Asymmetric Binocular NED), i.e., the OS systems are not identical and are not symmetric upon reflection around the CNB.

A principle at play is that the human brain, seeing different images via both eyes, will “choose” the highest quality (containing the best information) for every part of the merged image. Thus, for instance, if in one eye, part of the image is blurry and in the other eye it is not, the merged image will not look blurry to the user. If in one eye some information of an object is obscured, the information would be gained via the second eye. This statement is very general and, of course, would vary between different persons and cases, however, to some extent it is common to many NED users.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates an exemplary implementation of a near-eye display (NED) device.

FIGS. 2A-2C illustrate a user U wearing a basic symmetric NED system.

FIG. 3 illustrates the user U wearing an asymmetric binocular near-eye display system.

FIG. 4 illustrates the user U wearing an asymmetric binocular near-eye display system.

FIG. 5 illustrates the user U wearing an asymmetric binocular near-eye display system.

FIG. 6 illustrates side views of a first optical system and a second optical system of an asymmetric binocular near-eye display system.

FIG. 7 illustrates side views of a first optical system and a second optical system of an asymmetric binocular near-eye display system.

FIG. 8 is a schematic illustration showing how the use of different micro display positions optimizes different parts of the FOV and, thus, increases the resolution for an asymmetric binocular NED system.

FIG. 9 is a flowchart of an example process for an asymmetric binocular near-eye display system.

### DETAILED DESCRIPTION

Certain embodiments of the present invention provide a light projecting system and an optical system for achieving optical aperture expansion for the purpose of, for example, head-mounted displays (HMDs) or near-eye displays, commonly known as smart glasses, which may be virtual reality or augmented reality displays. Consumer demands for better and more comfortable human computer interfaces have stimulated demand for better image quality and for smaller devices.

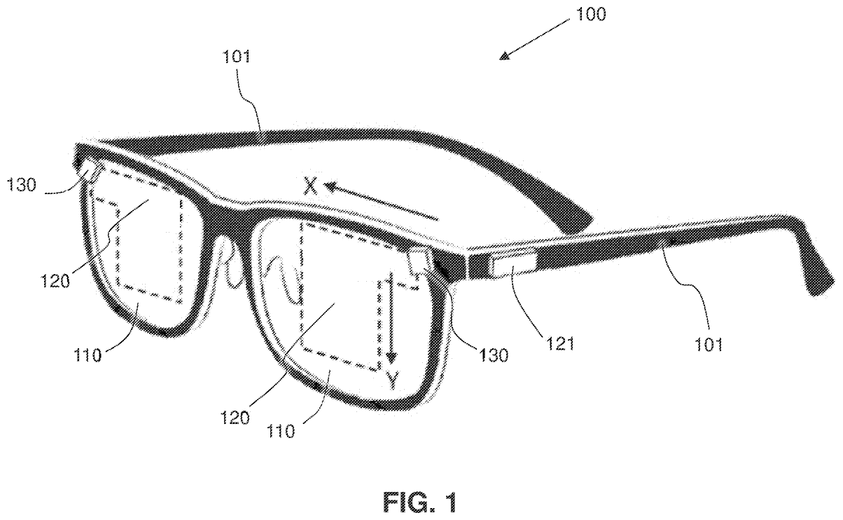

FIG. 1 illustrates an exemplary implementation of a near-eye display device according to the teachings of an embodiment of the present invention, generally designated 100. The near-eye display device 100 is disclosed here merely as an example and the inventive techniques disclosed herein are not limited to such devices.

In the illustrated embodiment of FIG. 1, the near-eye display 100 employs compact image projectors or projection units 130 optically coupled so as to inject an image into optical elements 120. The optical elements 120 may correspond to light-guide optical elements (LOE) within which the image light is trapped by total internal reflection at a set of planar external surfaces (“major external surfaces”) as described in U.S. Pat. Nos. 7,643,214 and 7,724,442.

Optical aperture expansion of light from the projection unit 130 may be achieved within optical elements 120 by one or more arrangements for progressively redirecting the image illumination, in the case of an LOE employing a set of partially reflecting surfaces (interchangeably referred to as “facets”) that are parallel to each other and inclined obliquely to the direction of propagation of the image light, with each successive facet deflecting a proportion of the image light into a deflected direction. Partially reflecting facets may also work as a coupling-out arrangement that progressively couples out a proportion of the image illumination towards the eye of an observer located within a region defined as the eye-motion box (EMB).

The optical element 120 as an LOE is disclosed here merely as an example and the inventive techniques disclosed herein are not limited to such devices, devices employing partially reflecting facets, etc. Similar functionality may be obtained using diffractive optical elements (DOEs) for redirecting and/or coupling-out of image illumination. Although the following text and figures focus on embedded refractive optical elements, rather than diffractive, this invention may apply equally to near eye displays based on diffractive or refractive embedded elements.

The overall device 100 is preferably supported relative to the head of a user with each projection unit 130 and optical elements 120 serving a corresponding eye of the user. In one particularly preferred option as illustrated here, a support arrangement is implemented as a face-mounted set of lenses (e.g., Rx lenses, sunglasses, etc., referred colloquially herein as “eye glasses”) with lenses 110 to which the projection unit 130 and optical element 120 are optically connected and a frame with sides 101 for supporting the device relative to ears of the user. Other forms of support arrangement may also be used, including but not limited to, head bands, visors or devices suspended from helmets.

The near-eye display 100 may include various additional components, typically including a controller 121 for actuating the projection unit 130, typically employing electrical power from a small onboard battery (not shown) or some other suitable power source. Controller 121 may include all necessary electronic components such as at least one processor or processing circuitry to drive the image projector.

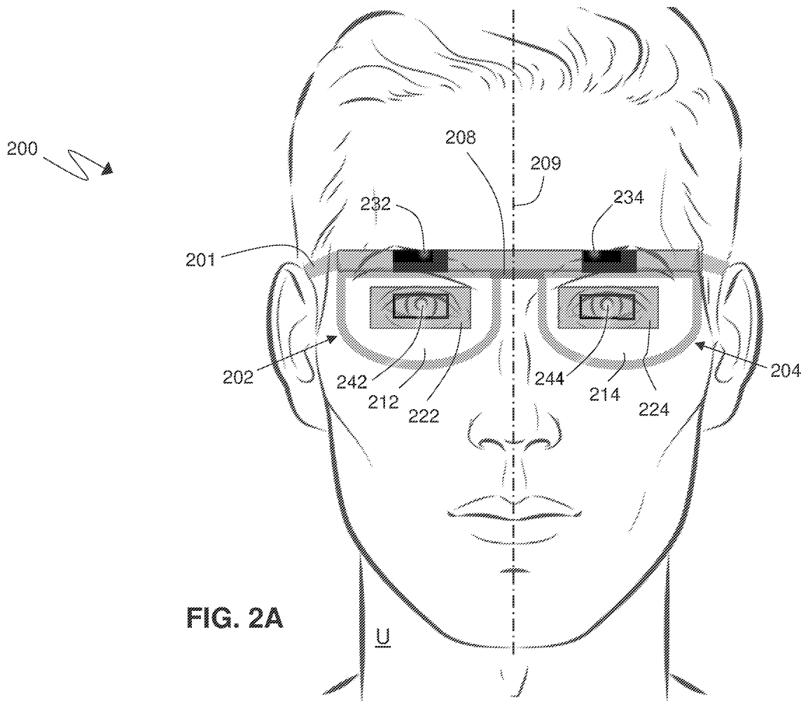

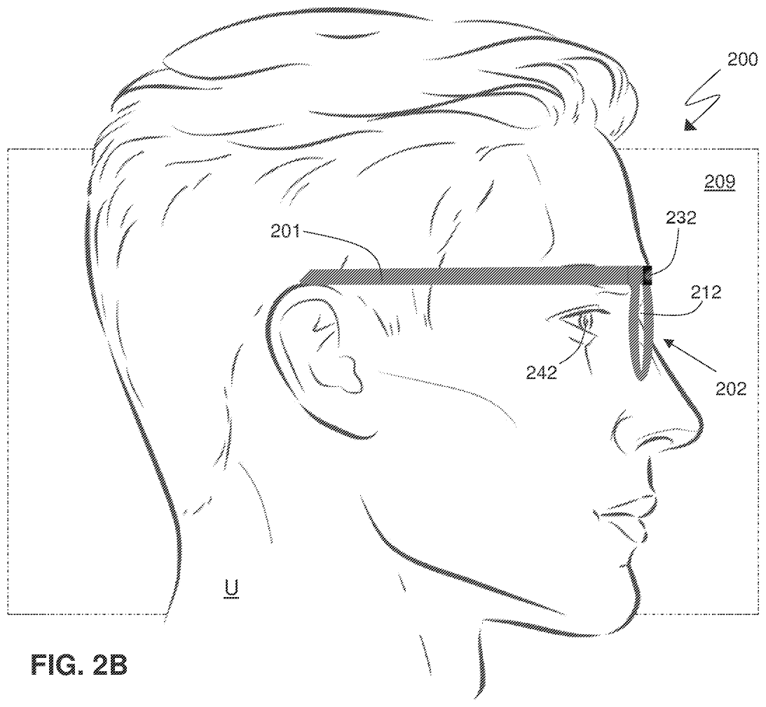

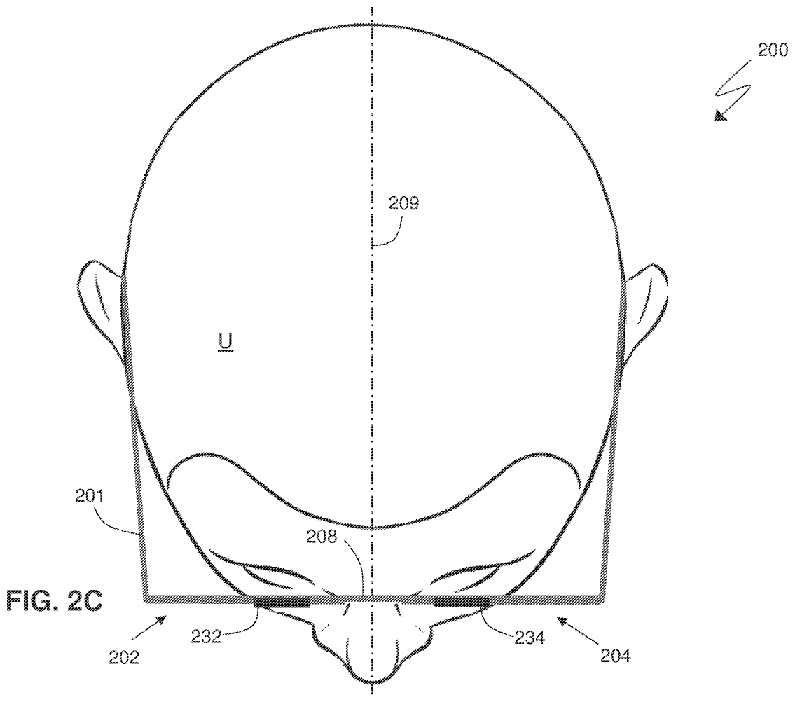

FIGS. 2A-2C illustrate front, side, and top views of a user U wearing a basic symmetric Near Eye Display (NED) system 200 similar to the system 100 of FIG. 1. The basic symmetric Near Eye Display (NED) system 200 may be in the form of glasses comprised of a frame 201. System 200 may also include two optical systems (OS), first OS 202 and second OS 204, one for each eye, and a nose bridge 208 at the center of frame 201. Mid-sagittal plane 209, intersecting the center of the nose bridge 208 (CNB) (i.e., bisecting the frame 201), may be centered between the two eyes of the user U and is the plane of symmetry for the eyes and for the NED system 200.

Each one of the first OS 202 and the second OS 204 may include at least three components: (1) lenses 212 and 214, (2) optical elements 222 and 224, and (3) projection units 232 and 234. The first lens 212 and second lens 214 may each incorporate a corresponding optical element 222, 224, which are positioned in front of the user's eye motion boxes (EMBs), first EMB 242 and second EMB 244.

Each of projection units 232, 234 may correspond to a projection unit similar to the projection unit 130 of FIG. 1 or to an output portion of the projection unit 130. As such, the projection units 232, 234 may contain a micro display and/or imaging optics. Unlike the projection unit 130 of FIG. 1, in accordance with some embodiments of the present invention, the first projection unit 232 and the second projection unit 234 may be positioned above the eyes of the user as seen in FIG. 2A, or elsewhere, for instance, on the side of the eyes of the user. If the first projection unit 232 and the second projection unit 234 are positioned above the eyes, the first OS 202 and the second OS 204 may be identical. However, if the first projection unit 232 and the second projection unit 234 are positioned on the side of the eyes, the first OS 202 and the second OS 204 may not be identical but rather symmetric.

The first EMB 242 and the second EMB 244 are typically at a distance ranging between 11 to 24 mm (usually referred as eye relief) from the first lens 212 and the second lens 214, respectively. The first optical element 222 and the second optical element 224 deflect light from the first projection unit 232 and the second projection unit 234 to the first EMB 242 and the second EMB 244, respectively. Each one of the first optical element 222 and the second optical element 224 may have optical power to assist in imaging the micro display of the first and second projection units 232, 234 at the user's retina or expand the aperture of the system, and thus, increase the area of the first EMB 242 and the second EMB 244.

In the embodiment of FIGS. 2A-2C, if the first and second EMB 242, 244 are to be symmetric about the mid-sagittal plane 209, the first and second lenses 212, 214, the first and second optical elements 222, 224, and the first and second projection units 232, 234 are the same as each other or mirror images of each other, to ensure symmetry.

In accordance with some embodiments of the present invention, if the first and second EMB 242, 244 are not symmetric about mid-sagittal plane 209, the effective merged EMB the user experiences may increase in size, at least for the definition of EMB as the area where the full FOV of the image reaches the users eyes even with very low brightness. For instance, if each one of the first EMB 242 and the second EMB 244 is a rectangle with horizontal and vertical widths of H₀×V₀, and if the two OSs 202, 204 are shifted asymmetrically (up-down, down-up, right-right or left-left) relative to the mid-sagittal plane 209 by a distance ±d₀, the resulting merged EMB for both eyes may be (H₀+2d₀)×V₀ for horizontal shift or H₀×(V₀+2d₀) for vertical shift. Breaking the symmetry between the EMB of each eye, i.e., the first EMB 242 and the second EMB 244 may be done by various ways as described below.

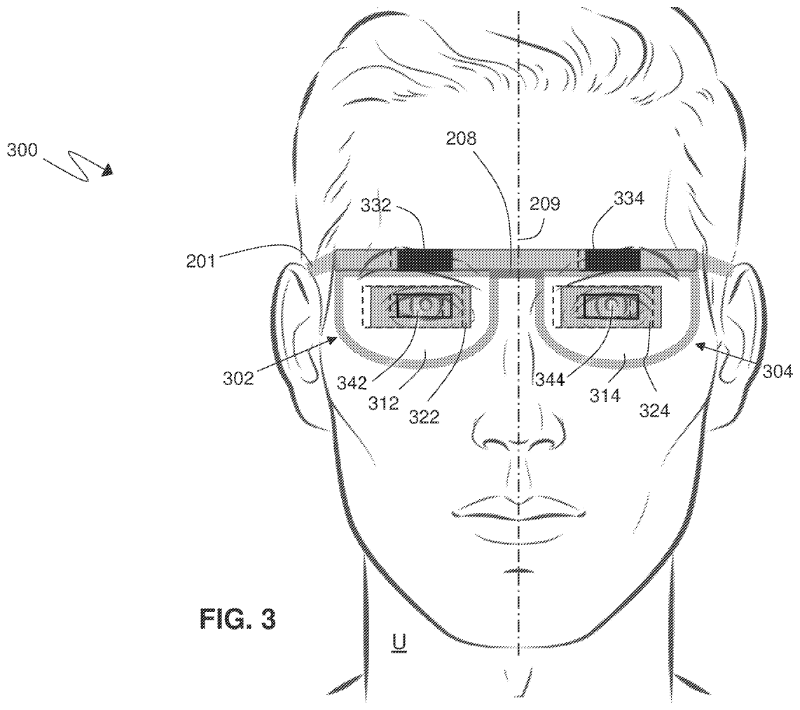

FIG. 3 illustrates the user U wearing an asymmetric binocular near-eye display system 300 with asymmetric projection units (PUs) 332, 334 and lenses 312, 314 with asymmetric optical elements 322, 324 for changing the EMB 342, 344. System 300 includes many of the same components as system 200 including glasses comprised of a frame 201, two optical systems (OS), first OS 302 and second OS 304, one for each eye, and a nose bridge 208.

In accordance with some embodiments of the present invention, each one of the first and second OS 302, 304 includes at least three components: (1) lenses 312 and 314, (2) optical elements 322 and 324, and (3) projection units 332 and 334. The first lens 312 and second lens 314 may each incorporate a corresponding optical element 322, 324, which are positioned in front of the user's eye motion boxes (EMBs), first EMB 342 and second EMB 344.

The first and second optical elements 322, 324 deflect light from the first and second projection units 332, 334 to the first and second EMB 342, 344, respectively. Each one of the first and second optical elements 322, 324 may have optical power to assist in imaging the micro displays of the first and second projection units 332, 334 at the user's retina or expand the aperture of the system and thus increase the first and second EMB 342, 344.

In FIG. 3, the dashed rectangles represent the positions of the first and second projection units 232, 234, the first and second optical elements 222, 224, and the resulting EMB 242, 244 of the system 200 of FIGS. 2A-2C. As can be seen in FIG. 3, to increase the effective area covered by the NED system 300 horizontally relative to the NED system 200, both the first and second projection units 332, 334 and the first and second optical elements 322, 324 are shifted towards the right ear of the user, resulting in the first and second OS 302, 304 and, therefore, the first and second EMB 342, 344 being asymmetric upon reflection around the mid-sagittal plane 209. As a result, the effective area covered by the NED system 300 increases horizontally relative to the NED system 200.

In system 300, the first and second optical elements 322, 324 may have optical power, such as for instance, free form prism (FFP), birdbath (BB), and the like. In accordance with some embodiments of the present invention (including those disclosed in FIGS. 3-8), although the first and second projection units and/or the first and second optical elements are not symmetrical about the center of the nose bridge 208 or the plane 209, the frame 201 can be symmetrical about the center of the nose bridge 208 or the plane 209 to maintain proper appearance of the glasses.

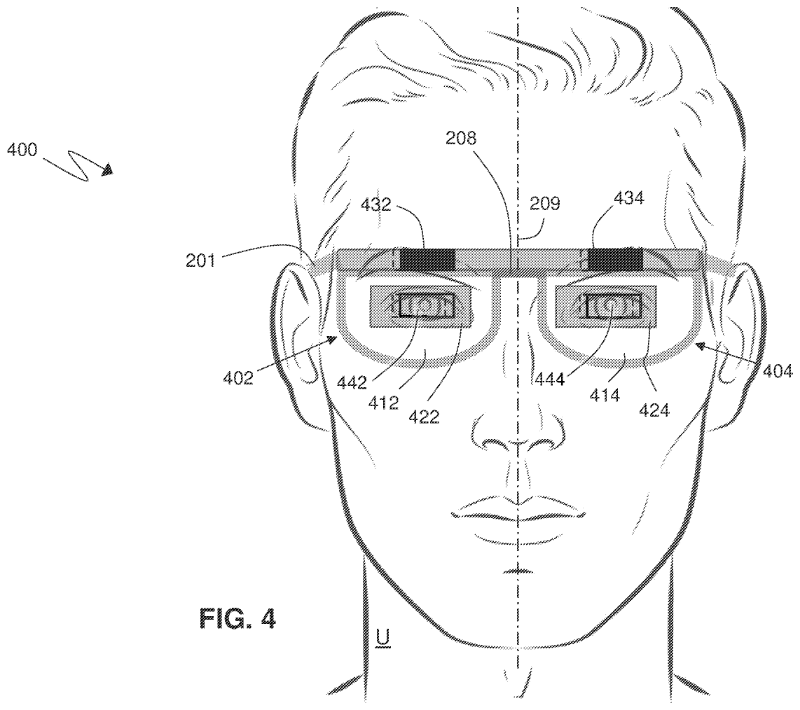

FIG. 4 illustrates the user U wearing an asymmetric binocular near-eye display system 400 with asymmetric projection units 432, 434 for changing the EMB 442, 444. System 400 includes many of the same components as the systems 200 and 300 including glasses comprised of a frame 201, two optical systems (OS), first OS 402 and second OS 404, one for each eye, and a nose bridge 208.

In accordance with some embodiments of the present invention, each one of the first and second OS 402, 404 includes at least three components: (1) lenses 412 and 414, (2) optical elements 422 and 424, and (3) projection units 432 and 434. The first lens 412 and second lens 414 may each incorporate a corresponding optical element 422, 424, which are positioned in front of the user's eye motion boxes first EMB 442 and second EMB 444.

The first and second optical elements 422, 424 deflect light from the first and second projection units 432, 434 to the first and second EMB 442, 444, respectively. Each one of the first and second optical elements 422, 424 may have optical power to assist in imaging the micro display at the user's retina or expand the aperture of the system and thus increase the first and second EMB 442, 444.

In FIG. 4, the dashed rectangles represent the positions of the first and second projection units 232, 234 and the resulting EMB 242, 244 of the system 200 of FIGS. 2A-2C. As can be seen in FIG. 4, to increase the effective area covered by the NED system 400 horizontally relative to the NED system 200, only the first and second projection units 332, 334 (and not the first and second optical elements 322, 324 as in the system 200 of FIG. 3) are shifted towards the right ear of the user, resulting in the first and second OS 402, 404 and, therefore, the first and second EMB 442, 444 being asymmetric upon reflection around the mid-sagittal plane 209. As a result, the effective area covered by the NED system 400 increases horizontally relative to the NED system 200.

For instance, each one of the first and second optical elements 422, 424 may comprise a plurality of partial facets vertically expanding the apertures of the images projected via the first and second projection units 432 and 434 to induce changes along the horizontal axis perpendicular to the plane 209, i.e., to shift the first and second EMB 442, 444 as shown in FIG. 4.

Alternatively, the first and second optical elements 422, 424 may include expanding apertures gratings, a simple beam splitter, and the like for expanding the apertures of the images projected via the first and second projection units 432 and 434, and thus, for shifting the first and second EMB 442, 444.

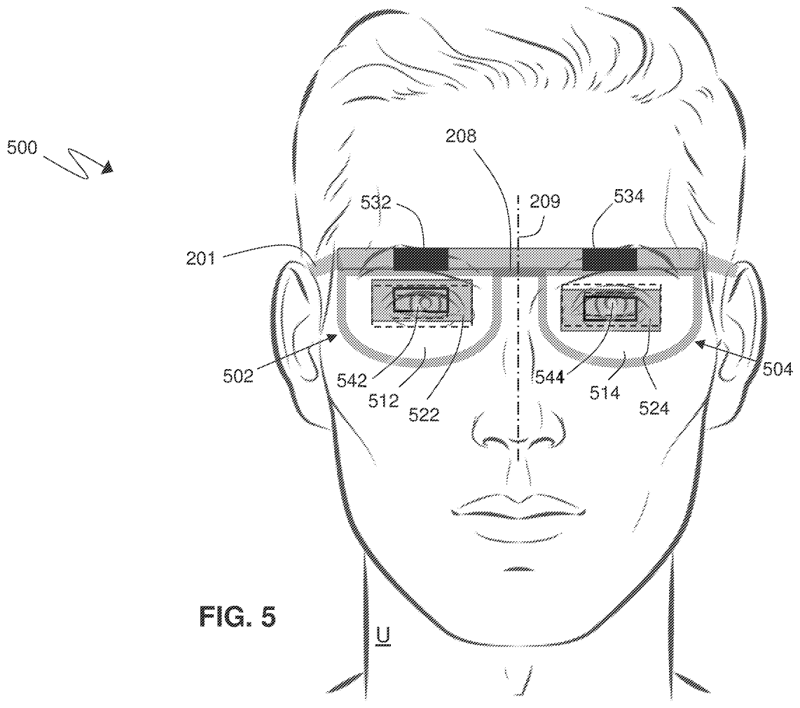

FIG. 5 illustrates the user U wearing an asymmetric binocular near-eye display system 500 with asymmetric first and second optical elements 522, 524 for changing the EMB 542, 544. The system 500 includes many of the same components as the systems 200, 300, and 400 including glasses comprised of a frame 201, two optical systems (OS), first OS 502 and second OS 504, one for each eye, and a mid-sagittal plane 209 corresponding to the center nose bridge 208.

In accordance with some embodiments of the present invention, each one of the first and second OS 502, 504 includes at least three components: (1) lenses 512 and 514, (2) optical elements 522 and 524, and (3) projection units 532 and 534. The first lens 512 and second lens 514 may each incorporate a corresponding optical element 522, 524, which are positioned in front of the user's eye motion boxes first EMB 542 and second EMB 544.

Each optical element 522, 524 comprises at least one coupling surface, coupling and deflecting the light projected by the first and second projection units 532 and 534 to the first and second EMB 542, 544, respectively. Each one of the first and second optical elements 522, 524 may have optical power to assist in imaging the micro display at the user's retina or expand the aperture of the system and thus increase the first and second EMB 542, 544.

In the embodiment of FIG. 5, only the first and second optical elements 522, 524 are shifted, causing the shift of the first and second EMB 542, 544, respectively.

In accordance with some embodiments of the present invention, the first and second optical elements 522, 524 may comprise a plurality of partial surfaces vertically expanding the apertures of the system. The first and second optical elements 522, 524 may be shifted vertically, resulting in vertical shifting of the first and second EMB 542, 544 and thus effectively increasing the merged EMB vertical height. In one embodiment, the first and second optical elements 522, 524 may be shifted vertically and horizontally, resulting in vertical and horizontal shifting of the first and second EMB 542, 544.

Alternatively, the first and second optical elements 522, 524 may comprise expanding aperture gratings, a simple beam splitter, and the like for inducing a vertical shift of the first and second EMB 542, 544.

In accordance with some embodiments of the present invention, the asymmetry between the OSs 502 and 504 may be exploited for improving the effective resolution of an asymmetric binocular near-eye display.

Following the basic idea that the brain chooses the best quality information between two images of two eyes, in accordance with some embodiments of the present invention, if part of the image has higher resolution at one eye and another part of the image has higher resolution at the other eye, the merged image may have an increased quality in both parts. For instance, if one OS having optimal resolution in one image area (for example at the center of the image) and the second OS having optimal resolution in a different area (for instance, at the external area), the merged binocular image may have optimal resolution in both areas.

If the asymmetric binocular near-eye display system includes pupil expansion, the optical element may have multiple performances on different areas of the image. For instance, if the optical element includes a set of parallel partial reflective surfaces, as in the light-guide optical element (LOE) described in U.S. Pat. Nos. 7,643,214 and 7,724,442, the resolution of the image may decrease when light reaches the user's eye pupil from two different surfaces and not from a single surface.

In accordance with some embodiments of the present invention, the optical element of a first asymmetric binocular near-eye display system OS and the optical element of a second OS may be shifted by a predefined distance, for instance, by a half of a single surface width of a single partially-reflecting surface, such that an area having low/high resolution at one eye does not overlap with an area having low/high resolution at another eye. The merged image may have an increased resolution, higher than the resolution of each image (at each eye).

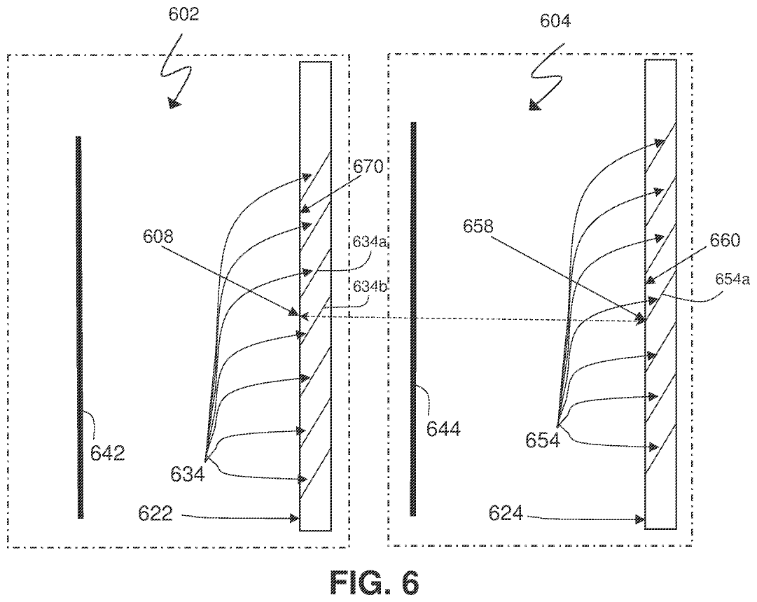

Such an example is shown in FIG. 6, which illustrates side views of a first optical system 602 and a second optical system 604 of an asymmetric binocular near-eye display system. The optical system 602 may correspond to a right eye and the optical system 604 may correspond to a left eye of the same asymmetric binocular near-eye display system. The figures show how the use of asymmetric optical elements 622 and 624 increases the resolution of the binocular near-eye display system. The optical elements 622, 624 may correspond to light-guide optical elements (LOE) within which the image light is trapped by total internal reflection at a set of planar external surfaces (“major external surfaces”) and coupled out by partially-reflecting surfaces as described in U.S. Pat. Nos. 7,643,214 and 7,724,442, hereby incorporated herein by reference.

In FIG. 6, first OS system 602 incorporates the first optical element 622 having a first inner array of surfaces 634 shining light towards the first EMB 642, and second OS system 604 incorporates the second optical element 624 having second inner array of surfaces 654 shine light towards the second EMB 644.

The first inner array of surfaces 634 and the second inner array of surfaces 654 are shifted relative to each other by half of the width of a single surface. Because the center 658 of surface 660 of the second OS system 604 coincides with an end of a partially reflecting surface 654a, edge effects negatively affect light impinging on the center 658 of the surface 660, resulting in diminished resolution at this location. However, in the novel system of FIG. 6, the center 658 of surface 660 of the second OS system 604 corresponds to the center 608 of surface 670 the first optical element 622 and the center 608 is located between two different partially reflecting surfaces 634a and 634b. Therefore, the image corresponding to OS 602 would not suffer from the same negative edge effects at this center location 608. The area with low resolution 658 overlaps with an area of high resolution 608. Therefore, areas with low resolution do not overlap between the two eyes and, because the user's brain will utilize the better solution image, the merged image has optimal resolution.

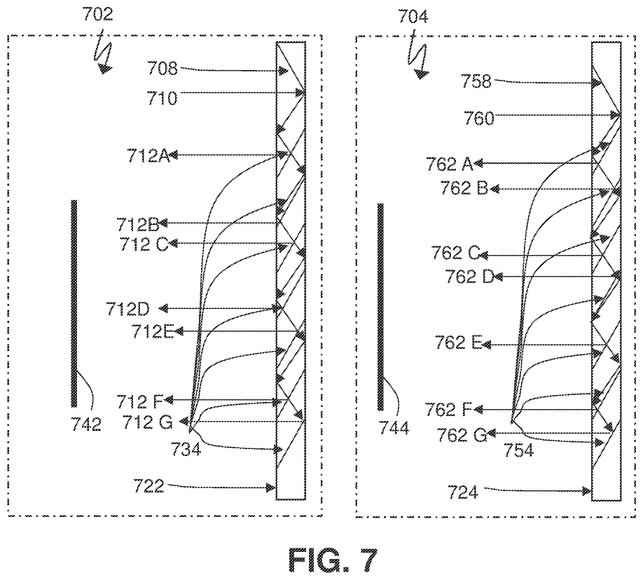

A similar disclosure is shown in FIG. 7, which illustrates side views of a first OS 702 and a second OS 704 of an asymmetric binocular near-eye display system. The figures show how the use of an asymmetric coupling element in a waveguide may increase the resolution of the asymmetric binocular near-eye display system.

The coupling in the beam aperture propagates inside the waveguide and replicates itself. This is true for various kind of waveguides incorporating both a set of partial reflective surfaces or gratings and for all kinds of coupling schemes, such as for instance, coupling prism, coupling gratings, or coupling inner reflective surfaces as seen in FIG. 7.

The resolution of the displayed image decreases at the edge of the one replica of the input aperture, and the following replica. Thus, if the distance between the active area (area at which light is deflected towards the EMB 742) and the EMB 742 in the first OS 702 is different from the distance between the active area (area at which light is deflected towards the EMB 744) and the EMB 744 in the second OS 704, areas of lower resolution may not be the same in both OSs 702, 704. The optical elements 722, 724 may correspond to light-guide optical elements (LOE) within which the image light is trapped by total internal reflection at a set of planar external surfaces (“major external surfaces”) and coupled out by partially-reflecting surfaces as described in U.S. Pat. Nos. 7,643,214 and 7,724,442, hereby incorporated herein by reference.

In FIG. 7, first OS 702 incorporates the first optical element 722 having a first inner array of surfaces 734 deflecting light towards the first EMB 742 while the second OS 704 incorporates the second optical element 724 having a second inner array of surfaces 754 deflecting light towards the second EMB 744.

As seen in the figures, the relative position of the first inner array of surfaces 734 in the first optical element 722 of the first OS 702 is identical to the relative position of the second inner array of surfaces 754 in the second optical element 724 relative to the second optical element 724 of the second OS 704. Likewise, the relative position of the first EMB 742 with respect to the first optical element 722 of the first OS 702 is identical to the relative position of the second EMB 744 with respect to the optical element 724 of the second OS 704.

However, the optical location of input surface 708 (the partially reflective surface optically closest to the corresponding projection unit) of the first OS system 702 is different from the optical location of the input surface 758 (the partially reflective surface optically closest to the corresponding projection unit) of the second OS system 704 and so are the replicas of the input aperture propagating inside the waveguides. The input surface 708 is disposed optically closer to its corresponding projection unit than input surface 758 is to its corresponding projection unit.

As seen in FIG. 7, rays 710 and 760 follow the edge of replica at which the resolution is usually lower. As seen, light is reflected outwards at different positions by the set of reflective surfaces at different positions, for instance, at positions 712A-712G on the first inner array of surfaces 734 of lens 702 and at positions 762A-762G on the second inner array of surfaces 754 of lens 752. However, the positions 712A-712G on the first inner array of surfaces 734 of lens 702 do not overlap with positions 762A-762G on the second inner array of surfaces 754 of lens 752.

As noted above, FIG. 7 illustrates an example of a waveguide with partial reflective surfaces. However, waveguides incorporating various other coupling in/out mechanisms may be used as well.

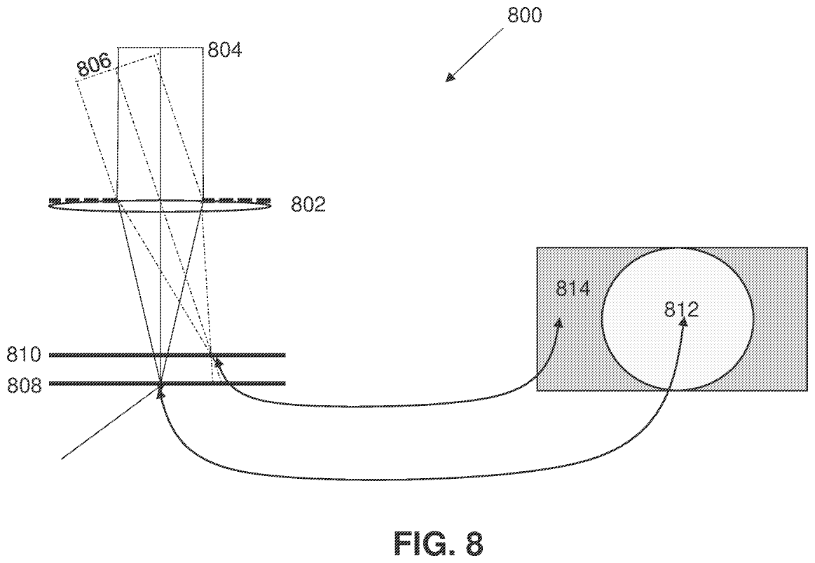

FIG. 8 is a schematic illustration showing how the use of different micro display positions optimizes different parts of the FOV and, thus, increases the resolution for an asymmetric binocular NED system. Seen in the figure is an imaging lens 802 of the OS. The imaging lens 802 has one depth of focus for the central area 804 of an image and another depth of focus for the side area 806 of the image.

In accordance with some embodiments of the present invention, at least two micro display positions are to be considered, first micro display position 808 and second micro display position 810, optimizing the two different fields.

In the disclosed asymmetric binocular system of the present invention, at a first OS, the center of FOV area may be optimized (position 808 corresponds to optimizing area 812). At the second OS, image-area 814 may be optimized when the position of the micro display would be closer to 810.

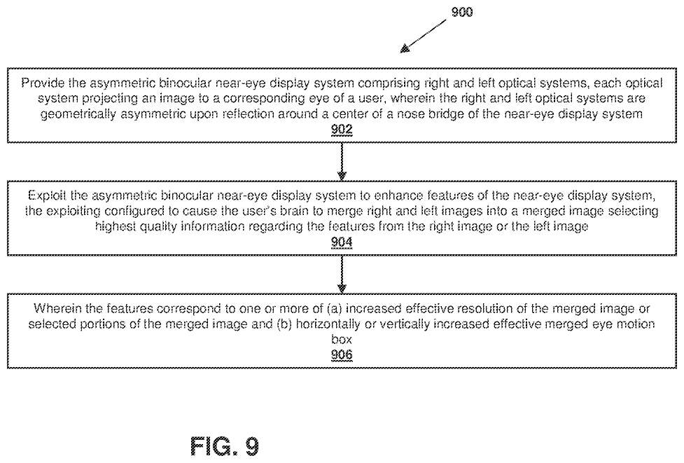

Exemplary methods may be better appreciated with reference to the flow diagram of FIG. 9. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 9 is a flowchart of an example process 900. In some implementations, one or more process blocks of FIG. 9 may be performed by a device. As shown in FIG. 9, process 900 may include providing the asymmetric binocular near-eye display system having right and left optical systems, each optical system projecting an image to a corresponding eye of a user, where the right and left optical systems are geometrically asymmetric upon reflection about a center of the nose bridge of the near-eye display system (block 902). For example, the device may provide the asymmetric binocular near-eye display system having right and left optical systems, each optical system projecting an image to a corresponding eye of a user, where the right and left optical systems are geometrically asymmetric upon reflection about a center of the nose bridge of the near-eye display system, as described above. As also shown in FIG. 9, process 900 may include exploiting the asymmetric binocular near-eye display system to enhance features of the near-eye display system, the exploiting configured to cause the user's brain to merge right and left images into a merged image selecting highest quality information regarding the features from the right image or the left image, (block 904). For example, the device may exploit the asymmetric binocular near-eye display system to enhance features of the near-eye display system, the exploiting configured to cause the user's brain to merge right and left images into a merged image selecting highest quality information regarding the features from the right image or the left image, as described above. As further shown in FIG. 9, process 900 specifies that the improved upon features may correspond to one or more of (a) increased effective resolution of the merged image or selected portions of the merged image and (b) horizontally or vertically increased effective merged eye motion box (block 906).

Although FIG. 9 shows example blocks of process 900, in some embodiments, process 900 may include additional blocks, fewer blocks, different blocks, or differently arranged blocks from those depicted in FIG. 9. Additionally, or alternatively, two or more of the blocks of process 900 may be performed in parallel.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1. An asymmetric binocular near-eye display system, comprising:
a frame configured for a user to wear and bisected by a mid-sagittal plane; and
a first optical system corresponding to a first eye of the user and a second optical system corresponding to a second eye of the user, each of the first and second optical systems comprising:
a projection unit operably mounted to the frame and configured to project light corresponding to an image;
a lens operably mounted to the frame and including an optical element configured to direct the light from the projection unit to a respective eye motion box of the user;
wherein the first and second optical systems are disposed in predefined, geometrically asymmetric positions about the mid-sagittal plane.

2. The asymmetric binocular near-eye display system of claim 1, wherein a projection unit of the first optical system and a projection unit of the second optical system are asymmetrically disposed about the mid-sagittal plane such that the eye motion box corresponding to the first optical system and the eye motion box corresponding to the second optical system are asymmetric about the mid-sagittal plane.

3. The asymmetric binocular near-eye display system of claim 1, wherein the optical element of the first optical system and the optical element of the second optical system are asymmetrically disposed about the mid-sagittal plane.

4. The asymmetric binocular near-eye display system of claim 1, wherein a projection unit of the first optical system and a projection unit of the second optical system are asymmetrically disposed about the mid-sagittal plane, and the optical element of the first optical system and the optical element of the second optical system are asymmetrically disposed about the mid-sagittal plane.

5. The asymmetric binocular near-eye display system of claim 1, wherein a projection unit of the first optical system is disposed closer to the mid-sagittal plane than a projection unit of the second optical system such that the eye motion box corresponding to the first optical system and the eye motion box corresponding to the second optical system are horizontally asymmetric about the mid-sagittal plane.

6. The asymmetric binocular near-eye display system of claim 1, wherein the optical element of the first optical system is disposed closer to the mid-sagittal plane than the optical element of the second optical system.

7. The asymmetric binocular near-eye display system of claim 1, wherein the optical element of the first optical system is disposed vertically higher than the optical element of the second optical system.

8. The asymmetric binocular near-eye display system of claim 1, wherein the optical element of the first optical system is disposed closer to the mid-sagittal plane and vertically higher than the optical element of the second optical system.

9. The asymmetric binocular near-eye display system of claim 1,
wherein each of the optical element of the first optical system and the optical element of the second optical system include:
a set of major external surfaces,
a set of partially-reflecting surfaces disposed between the major external surfaces so that a part of image illumination propagating within the respective optical element by total internal reflection at said major external surfaces is coupled out of the optical element towards the respective eye motion box of the user,
wherein the set of partially-reflecting surfaces of the optical element of the first optical system are shifted along the optical element relative to the set of partially-reflecting surfaces of the optical element of the second optical system.

10. The asymmetric binocular near-eye display system of claim 9, the set of partially-reflecting surfaces of the optical element of the first optical system is shifted by half of the width of a single partially-reflecting surface relative to the set of partially-reflecting surfaces of the optical element of the second optical system.

11. The asymmetric binocular near-eye display system of claim 1,
wherein each of the optical element of the first optical system and the optical element of the second optical system include:
a set of major external surfaces,
a set of partially-reflecting surfaces disposed between the major external surfaces so that a part of image illumination propagating within the respective optical element by total internal reflection at said major external surfaces is coupled out of the optical element towards the respective eye motion box of the user,
wherein a partially-reflecting surface of the set of partially-reflecting surfaces of the optical element of the first optical system disposed optically closest to its respective projection unit is disposed optically closer to its respective projection unit than a partially-reflecting surface of the set of partially-reflecting surfaces of the optical element of the second optical system disposed optically closest to its respective projection unit is disposed optically closer to its respective projection unit.

12. The asymmetric binocular near-eye display system of claim 1, wherein the first optical system has a first depth of focus and the second optical system has a second depth of focus different from the first depth of focus.

13. The asymmetric binocular near-eye display system of claim 12, wherein the first depth of focus corresponds to a central area of the image and the second depth of focus corresponds to a side area of the image.

14. The asymmetric binocular near-eye display system of claim 12, wherein the first depth of focus corresponds to a first position of the projection unit of the first optical system and the second depth of focus corresponds to a second position of the projection unit of the second optical system, the first position different from the second position relative to their respective optical system.

15. A method for an asymmetric binocular near-eye display system, comprising:
providing the asymmetric binocular near-eye display system comprising right and left optical systems, each optical system projecting an image to a corresponding eye of a user, wherein the right and left optical systems are geometrically asymmetric upon reflection about a plane corresponding to a center of a nose bridge of the near-eye display system; and
exploiting the asymmetric binocular near-eye display system to enhance features of the near-eye display system, the exploiting configured to cause the user's brain to merge right and left images into a merged image selecting highest quality information regarding the features from the right image or the left image,
wherein the features correspond to one or more of (a) increased effective resolution of the merged image or selected portions of the merged image and (b) horizontally or vertically increased effective merged eye motion box.
